(19) United States
(12) Patent Application Publication
(10) Pub. No.: US 2011/0069018 A1
(43) Pub. Date: Mar. 24, 2011

(54) Double Touch Inputs

(75) Inventors: Graham Roy Atkins, Australian Capital Territory (AU); Ian Andrew Maxwell, New South Wales (AU)

(73) Assignee: RPO Pty Limited, Acton (AU)

(21) Appl. No.: 12/599,780

(22) PCT Filed: May 12, 2008
(86) PCT No.: PCT/AU08/00654

§ 371 Date: Jun. 22, 2010

(30) Foreign Application Priority Data
May 11, 2007 (AU) 2007902509

(51) Int. Cl. G06F 3/041

(52) U.S. Cl. 345/173

(57) ABSTRACT

In the methods of the present invention a function is initiated with a first set of touches, then applied with a second set of touches. The methods are advantageous for touch input devices with limited or no ability to detect two or more simultaneous touch events, but are not limited to being used on such input devices.

### CROSS-REFERENCE TO RELATED APPLICATIONS

This application claims priority from Australian provisional patent application No. 2007902509 filed on 11 May 2007, the contents of which are incorporated herein by reference.

### FIELD OF THE INVENTION

The present invention relates to a user interface method for a display device. It has been developed primarily for touch-screens and other touch sensitive devices and will be described hereinafter with reference to this application. However it will be appreciated that the invention is not limited to this particular field of use.

### BACKGROUND OF THE INVENTION

Any discussion of the prior art throughout the specification should in no way be considered as an admission that such prior art is widely known or forms part of the common general knowledge in the field.

Input devices based on touch sensing (touch screens) have long been used in electronic devices such as computers, personal digital assistants (PDAs), handheld games and point of sale kiosks, and are starting to appear in other portable consumer electronics devices such as mobile phones. Generally, touch-enabled devices allow a user to interact with the device by touching one or more graphical elements, such as icons or keys of a virtual keyboard, presented on a display. Several touch-sensing technologies are known, including resistive, capacitive, projected capacitive, surface acoustic wave and optical, all of which have advantages and disadvantages in areas such as cost, reliability, ease of viewing in bright light, ability to sense different types of touch object, e.g. finger, gloved finger, stylus, and single or multi-touch capability.

Gestural inputs, where a user moves one or more fingers (a thumb is considered to be a finger) across a touch-sensitive surface, or contacts one or more fingers with a touch-sensitive surface in a particular sequence, are an increasingly popular means for enhancing the power of touch input devices beyond the simple ‘touch to select’ function. Several types of gestural input for touch-sensitive devices have been proposed. Published U.S. Patent Application Nos. 2006/0022956, 2006/0026521 and 2006/0026535by Apple Computer Inc for instance disclose various mechanisms for activating one or more GUI (Graphical User Interface) elements based on a user interface mode and in response to one or more detected touches. The graphical elements that may be activated include a virtual scroll wheel, a virtual keyboard, a toolbar and a virtual music mixer, and functions that may be applied include translating (panning), inertial scrolling, rotating and re-sizing (enlarging or reducing). U.S. Pat. No. 5,825,352 to Logitech discloses a method and device for sensing mostly two-finger gestures that emulate mouse functions. These include two-finger dragging, however only multiple touches within a close range are accepted. U.S. Pat. No. 5,943,043 to IBM discloses a method and apparatus for detecting ‘double-touch inputs’ that appear to simply replicate the mouse double click. It is intended to be more accurate than conventional single finger double tapping on an icon since, for small icons it is alleged that the two taps may not be in the same spot.

Many of these gestures, such as the rotation and re-sizing gestures in U.S. 2006/0026535, require the simultaneous detection and tracking or two or more touch objects, which is an important consideration because the various touch-sensing technologies differ in their ability to detect more than one simultaneous touch object. Some early technologies such as resistive and capacitive are completely unsuited to detecting multiple touch events, reporting two simultaneous touch events as a ‘phantom touch’ halfway between the two actual points. On the other hand technologies such as projected capacitive (see Published U.S. Patent Application No. 2006/0097991 for example) and in-cell optical (see U.S. Pat. No. 7,166,966 and Published U.S. Patent Application No. 2006/0033016 for example) are well suited to detecting several simultaneous touch events. As discussed in U.S. Pat. No. 6,856,259,‘infrared’ and ‘surface acoustic wave’ (SAW) touch-sensing technologies, where a touch object is located when it blocks two intersecting paths of optical or acoustic power, occupy a middle ground in that they can routinely identify the presence of multiple touch events but, absent further information such as touch-down and lift-off timing, relative object sizes and expected touch locations, generally cannot determine their locations unambiguously.

To explain this ‘double touch ambiguity’, FIG. 1 shows an infrared-style touch input device 2 where two intersecting grids of parallel sensing beams 4 are emitted by arrays of discrete optical sources (e.g. LEDs) 6 along two sides of a rectangular input area 7, and detected by arrays of discrete photo-detectors 9 along the two opposing sides of the input area. This style of touch input device is well known, see U.S. Pat. Nos. 3,478,220 and 3,764,813 for example. If two objects 8 touch the input area simultaneously, in the absence of further information their true locations cannot be distinguished from the locations of two ‘phantom objects’ 10 at the other two corners of the notional rectangle 12. More generally, n simultaneous touch events will appear as n² ‘candidate points’ including n(n−1) ‘phantom’ points, so the complications increase quadratically with the number of simultaneous touch events.

For some known gestures requiring two simultaneous touches, such as re-sizing with two fingers (or finger and thumb), the double touch ambiguity does not cause a problem. Inspection of FIG. 1 shows that a displayed graphic underlying the notional rectangle 12 will be enlarged if the two fingers are moved apart, or reduced if they are moved together, irrespective of whether the two fingers are interpreted as being at the true locations 11 or at the phantom locations 13. However ‘two finger rotate’ is an example of a gesture that is not immune from the double touch ambiguity. As shown in FIG. 2A, if the control system of the touch input device correctly determines that a user's fingers are at the locations 11, and the user rotates them anticlockwise as shown by the arrows 14, then a displayed graphic 16 will be rotated anticlockwise as required. As shown in FIG. 2B on the other hand, the control system could equally well interpret this gesture as two fingers rotating clockwise from the phantom locations 13, in which case the graphic will be incorrectly rotated clockwise.

Gestures that require two sequential touches are much less likely to be affected by any double touch ambiguity, because the first touch point can always be located correctly before the second touch occurs. However complications can still arise if the control system has to track moving touch objects. For example if a user sequentially applies two fingers 8 to an input area 7 then moves them as shown by arrows 14 (FIG. 3A) into an ‘eclipse’ state (FIG. 3B), an ambiguity can occur in that the control system may be unable to determine whether the fingers continue moving in the same direction (FIG. 3C) or return along the reverse direction (FIG. 3D).

It is an object of the present invention to overcome or ameliorate at least one of the disadvantages of the prior art, or to provide a useful alternative.

### DISCLOSURE OF THE INVENTION

In a first broad aspect, the present invention provides a user interface method for a display device displaying one or more graphical elements, said method comprising:
initiating a function with a first set of touches on said display device; and applying said function with a second set of touches.

It will be appreciated that the first set of touches may also select or identify the function, and that the applied function may be executed or enabled by the second set of touches. In preferred embodiments the user may define where the second set of touches are to be received to apply/execute/enable the function. Alternatively, or additionally, the user can define various parameters of the second set of touches, for example speed of touch, frequency of touches, inputted gesture e.g. swirl, circle, swipe, etc, position of the second set of touches, time within which the second set of touches should be received, etc. In other words, the user may customise the order and timing of the second set of touches. In some preferred embodiments, the second set of touches may be performed anywhere on a touch-sensitive display surface. For example, the first set of touches on the display may be to initiate a rotation function and the second set of touches comprises a circular motion to effect the rotation. Prior art methods comprise a pre-defined input location where the inputted circular motion is expected to be received, however the present invention teaches away from the prior art in that the user may perform the second set of touches anywhere on the display to apply the function.

In a related aspect, the present invention provides a user interface method for a display device, said method comprising:
selecting or identifying a function with a first set of touches on said display device; and
enabling and executing said function at a location defined by a second set of touches.

Unlike the prior art, the user interface methods of the present invention have a second touch that is completely independent of the first touch. To explain, in the prior art the second touch is limited by or dependent on the first touch. For instance, the second touch must be in a pre-determined location or time frame relative to the first touch. This significantly limits the usefulness of the prior art methods.

Further, the prior art methods are not intended primarily for touches spaced arbitrarily far apart. Rather, they relate to touches closely spaced together. As will be described herein the methods of the present invention may select a function at one point on the display and then apply that function at an opposite point on the display or at a point completely unrelated to the initial touch. Lack of a causal relationship between the first and second sets of touches teaches away from the prior art, which typically teaches that some ‘link’ is required between a first and second touch to enable a function.

In one embodiment, the method additionally comprises the step of, prior to receipt of the first set of touches, defining a location on said display device for said second set of touches to apply said function. Alternatively, one or more touches of the first set of touches define a location on the display device for the second set of touches to apply the function.

In another embodiment, the step of performing the second set of touches may be performed by a user anywhere on a touch-sensitive surface of said display device, which may be free from any indication to a user of where said second set of touches is to be applied.

In preferred embodiments the first set of touches are removed from the display device before applying the function with the second set of touches. In alternative embodiments the first set of touches remain on the display device while applying the function with the second set of touches.

Various functions may be initiated and applied according to the present invention including:

a scroll function wherein the first set of touches initiates the scroll function and the second set of touches is a series of touches or taps, the speed of which controls the speed and/or direction of the scroll;

a rotation function wherein the first set of touches initiates the rotation function and optionally defines the centre of rotation, and the second set of touches implements rotation around the default or defined centre of rotation;

an erase/delete/highlight function wherein the first set of touches initiates such an erase/delete/highlight function and the second set of touches implements the function at a location indicated by the second set of touches; and

a ‘define plane and rotate’ function wherein the first set of touches initiates a rotation function and defines a plane of view of a graphical element, and the second set of touches rotates said plane.

The present invention separates initiation of a function with application of that function, using two separate sets of sequential touches. The first set of touches initiates the functionality and the second set of touches applies that functionality at a desired location. By use of two such sets of touches there is greater flexibility and efficiency with the display and the applied functionality. The specific gestures to be described are advantageously applicable to touch input devices with limited multi-touch capability (e.g. infrared and SAW devices) and touch input devices with no multi-touch capability (e.g. resistive), but are not limited to being used on such devices.

Gestural inputs can be useful whether the touch-sensitive surface of a touch input device has an underlying display (in which case the device may be termed a ‘touch screen’) or not (in which case the device may be termed a ‘touch panel’). In the embodiments described in this specification a user interacts via gestures with information presented on a display, so that at least part of the touch-sensitive surface has an underlying display, but it will be appreciated that other touch events, in particular some or all of the first set of touches used to initiate a function, could be performed on portions of a touch-sensitive surface without an underlying display.

While many touch-sensing technologies require a physical touch on a touch-sensitive surface to effect user input, other technologies such as ‘infrared’ and SAW where a grid of sensing beams is established in front of the surface, may also be sensitive to ‘near-touch’ events such as a hover. Although the specific embodiments described in this specification involve physical touches, it should be understood that terms such as ‘touch’ and ‘touch event’ include near-touch events.

### DESCRIPTION OF DRAWINGS

So that the present invention may be more clearly understood preferred embodiments will be described with reference to the accompanying drawings in which:

FIG. 1 illustrates a plan view of a prior art ‘infrared’ touch input device, showing an inherent double touch ambiguity;

FIG. 2A illustrates a ‘two finger rotate’ gesture being correctly interpreted by the touch input device of FIG. 1;

FIG. 2B illustrates a ‘two finger rotate’ gesture being incorrectly interpreted by the touch input device of FIG. 1;

FIGS. 3A to 3D illustrate how a double touch ambiguity can recur with two moving touch points;

FIGS. 4A and 4B illustrate a user interface method according to a first embodiment of the present invention;

FIGS. 5A to 5D illustrate a user interface method according to a second embodiment of the present invention;

FIGS. 6A to 6D illustrate a user interface method according to a third to embodiment of the present invention; and

FIGS. 7A and 7B illustrate a user interface method according to a fourth embodiment of the present invention.

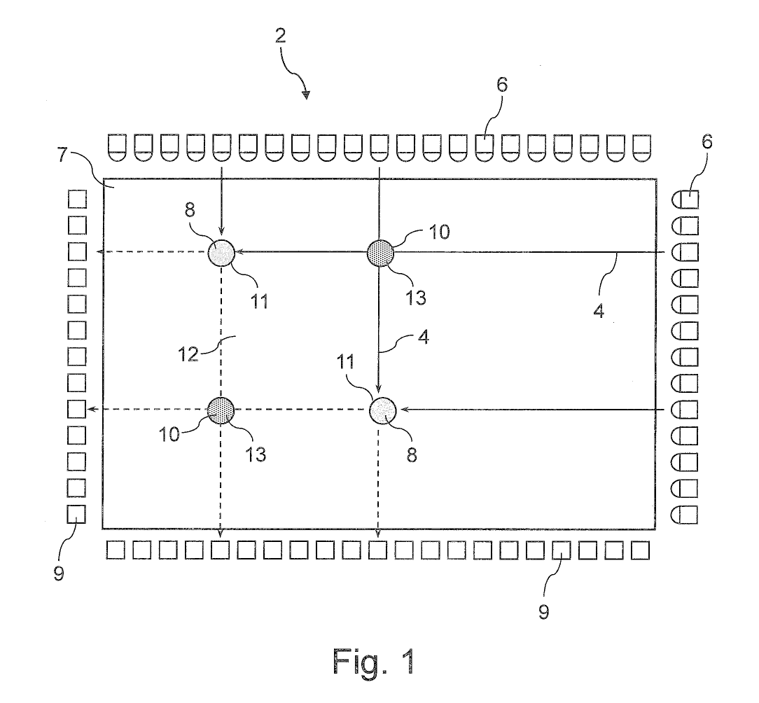

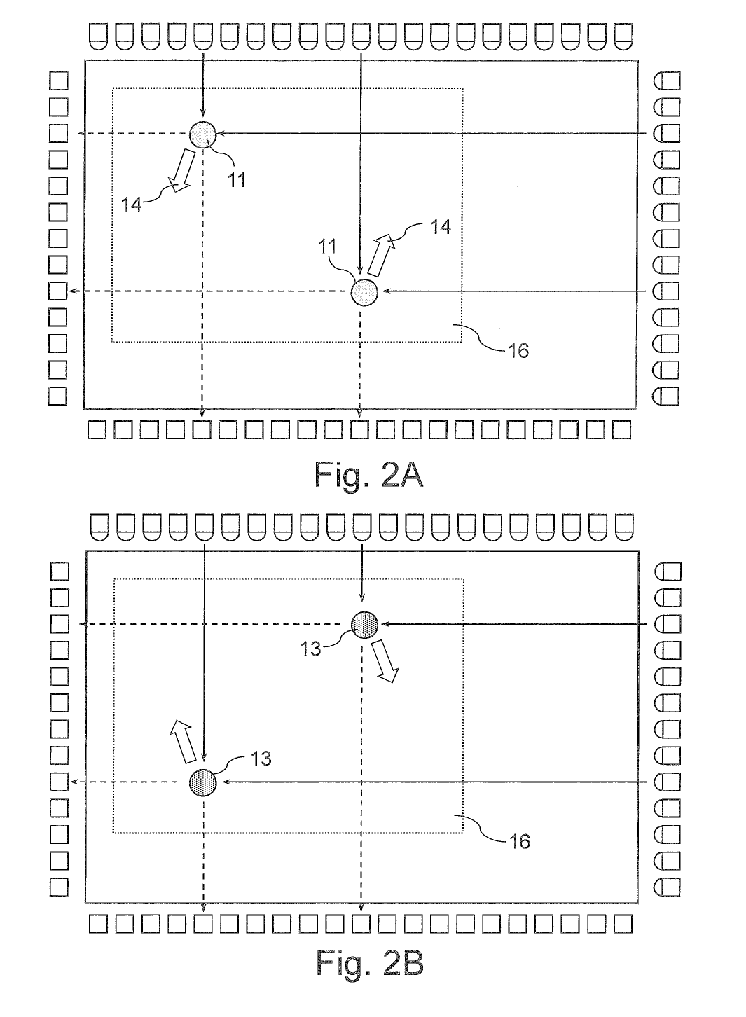

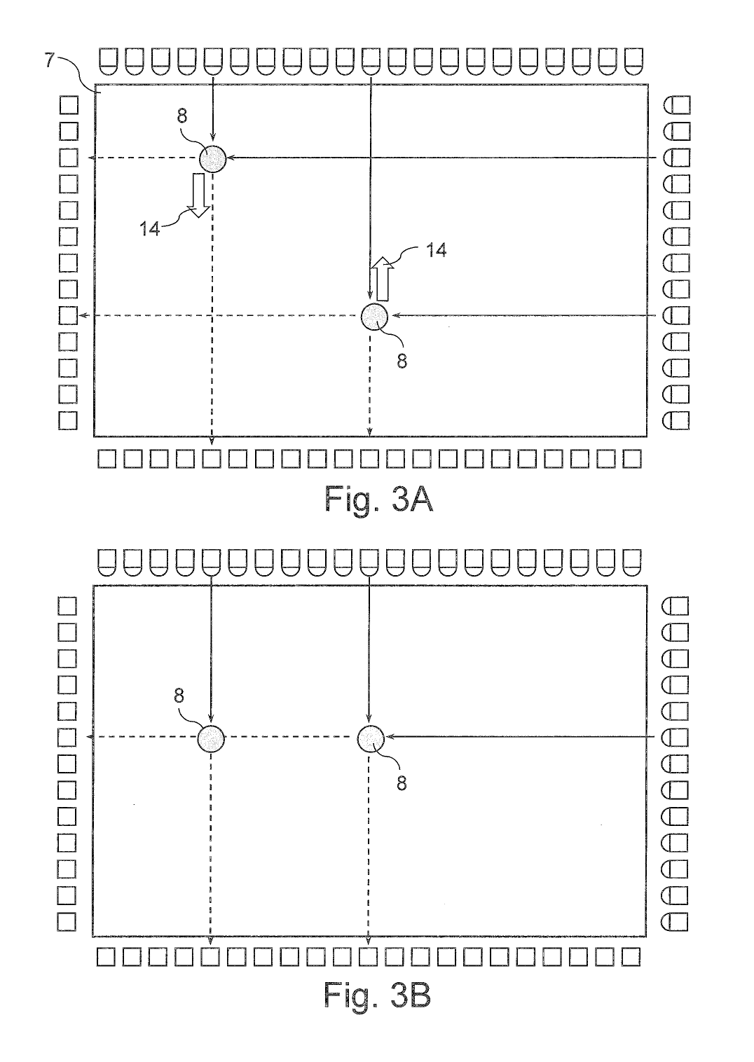

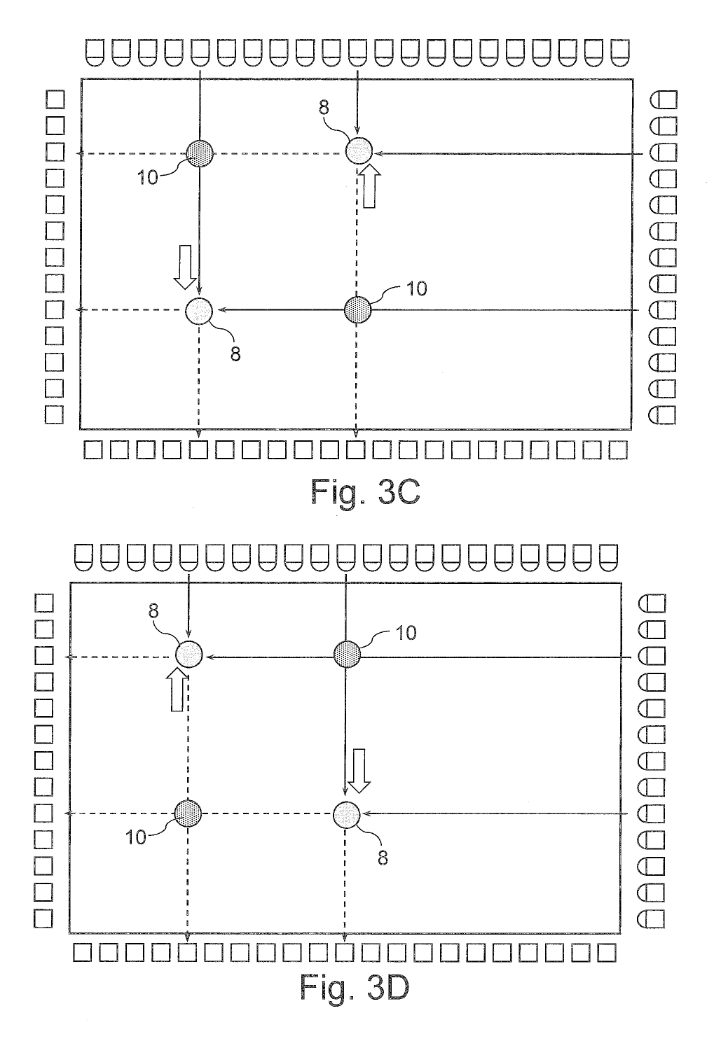

### PREFERRED EMBODIMENT OF THE INVENTION

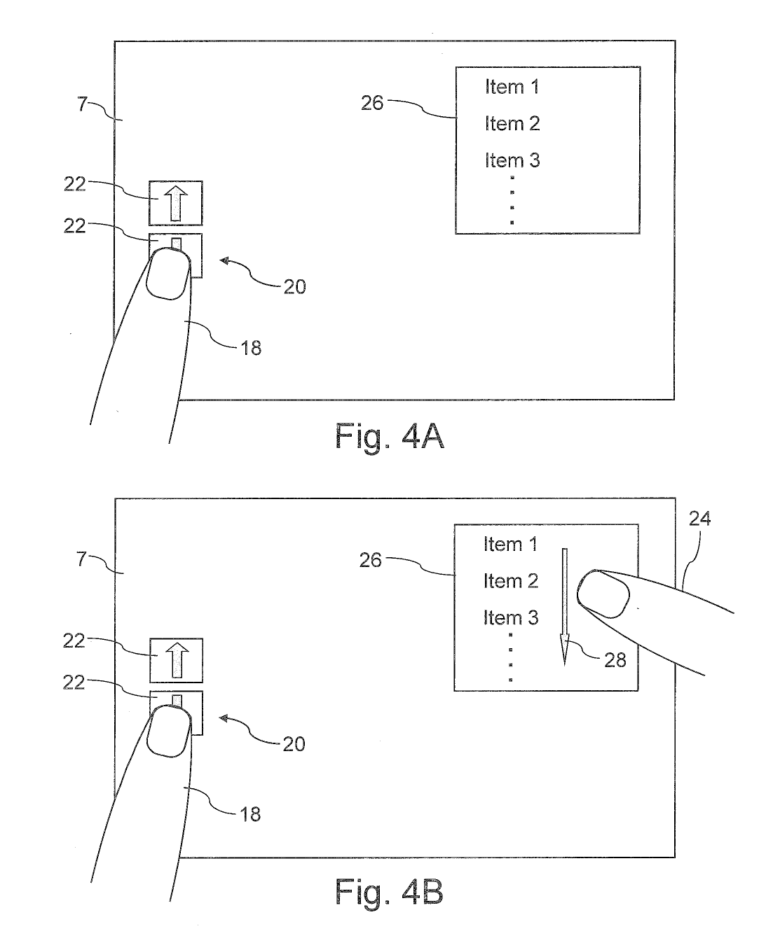

Referring to the drawings, a user interface method according to a first embodiment of the present invention is shown in FIGS. 4A and 4B. In this embodiment the functionality applied is a scroll function.

In this embodiment, a first set of touches in the form of a single touch 18 initiates a scroll function by touching at an appropriate location 20 of a touch-sensitive area or display 7, such as an arrow icon 22. Alternatively the first touch could be a swipe or slide mimicking a scroll function.

Once the scroll function is initiated, a second set of touches 24 is applied to the portion of the display containing a list of items 26 to be scrolled through. In one embodiment, where the scroll direction has been determined by the particular arrow icon 22 touched by the single touch 18, the second set of touches takes the form of a series of taps, with the scrolling speed determined by the tapping frequency. In another embodiment the second set of touches takes the form of one or more swipes in the desired scrolling direction 28.

In one embodiment, suitable for touch input devices with no multi-touch capability, the single touch 18 is removed before the second set of touches is applied, in which case the second set of touches will have to be applied or repeated (if in the form of a series of taps say) before the function is ‘timed out’. In another embodiment, the single (first) touch remains on the ‘scroll location’ 20 while the second set of touches applies the scroll function, and the scroll function is disabled upon removal of the first touch.

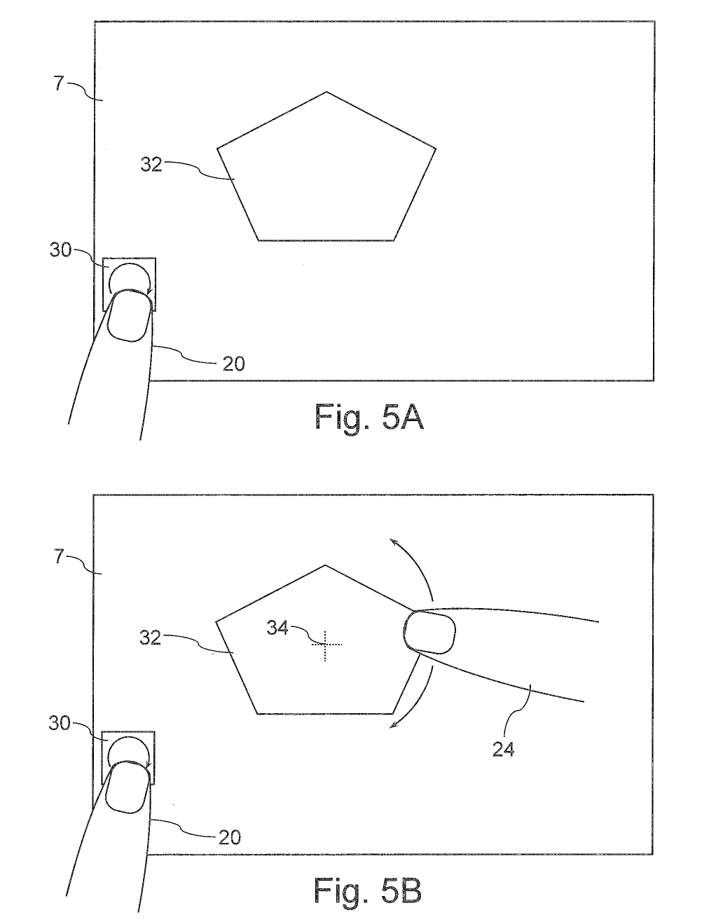

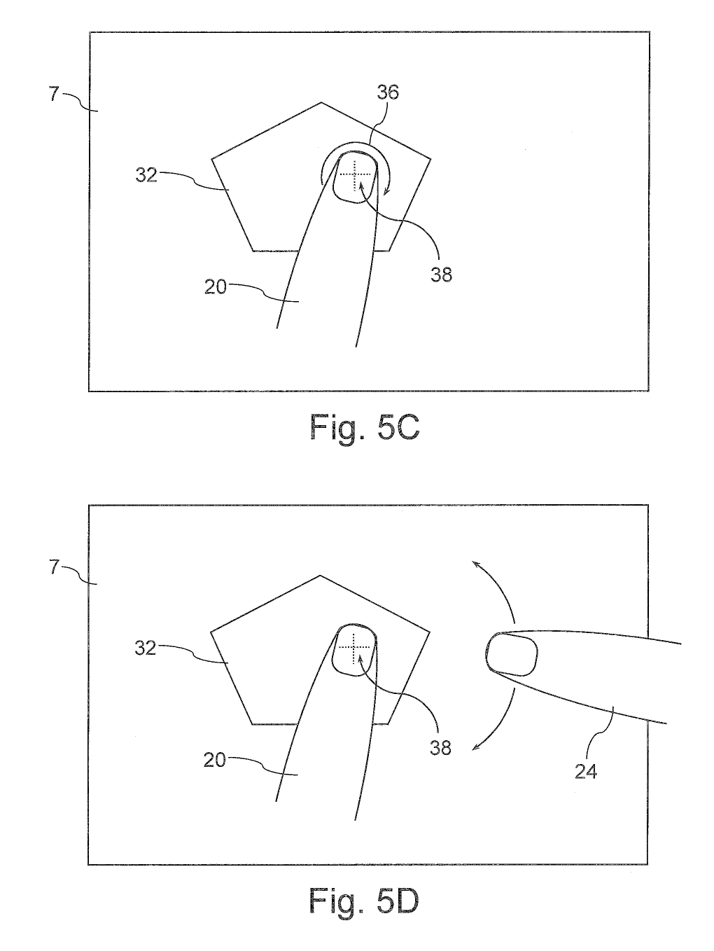

FIGS. 5A and 5B show a second embodiment of the present invention, where the user interface method relates to a rotation function. A first set of touches in the form of a single touch 20 initiates the rotational function in much the same way as the aforementioned scroll function ie by engagement of a ‘rotation’ icon 30. A second set of touches in the form of a directional swipe 24 on a displayed graphical element 32 then rotates the graphical element about its centre point 34, that being the default centre of rotation. In another embodiment a displayed graphic can be rotated around a different centre of rotation, the desired point being touched as part of the first set of touches while the touch 20 engages the rotation icon 30, and before the second set of touches performs the rotation. In one embodiment the rotation is freeform, while in another embodiment the rotation is restricted to fixed increments, for example 15, 30 or 90 degrees. There are many possible means by which the freeform and fixed rotation modes can be selected by the first set of touches. For example the first set of touches may select the fixed rotation mode by engaging a different icon with a single touch or by double tapping the rotation icon 30. As in the scroll function embodiment described above, the first set of touches may or may not be removed from the input area 7 before the second set of touches is applied.

FIGS. 5C and 5D show an alternative embodiment of a rotation function where a first set of touches in the form of a single touch 20 is placed on a displayed graphical element 32 and moved in a small circle 36 thereby giving an indication that the rotation function is required and defining a centre of rotation 38. Once the rotation function is initiated, a second set of touches in the form of a direction swipe 24 implements rotation around the centre of rotation 38. This is a significant advantage over the prior art since the second touch 24 does not need to be placed on the displayed graphical element 32 for that element to be rotated, which is particularly important if the graphical element is small and liable to be obscured by a touch object.

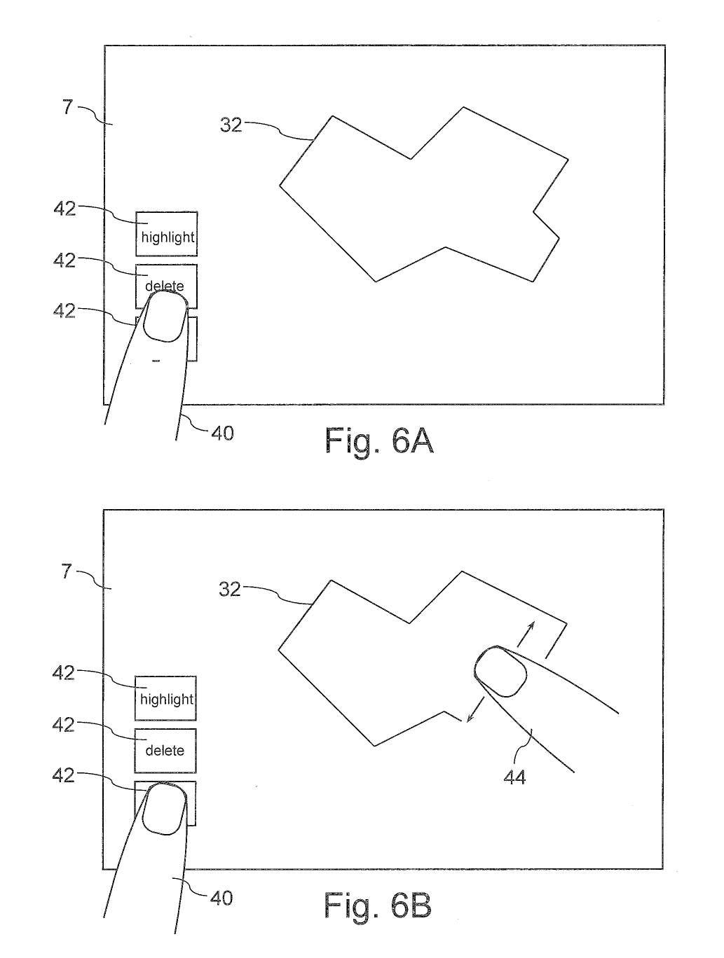

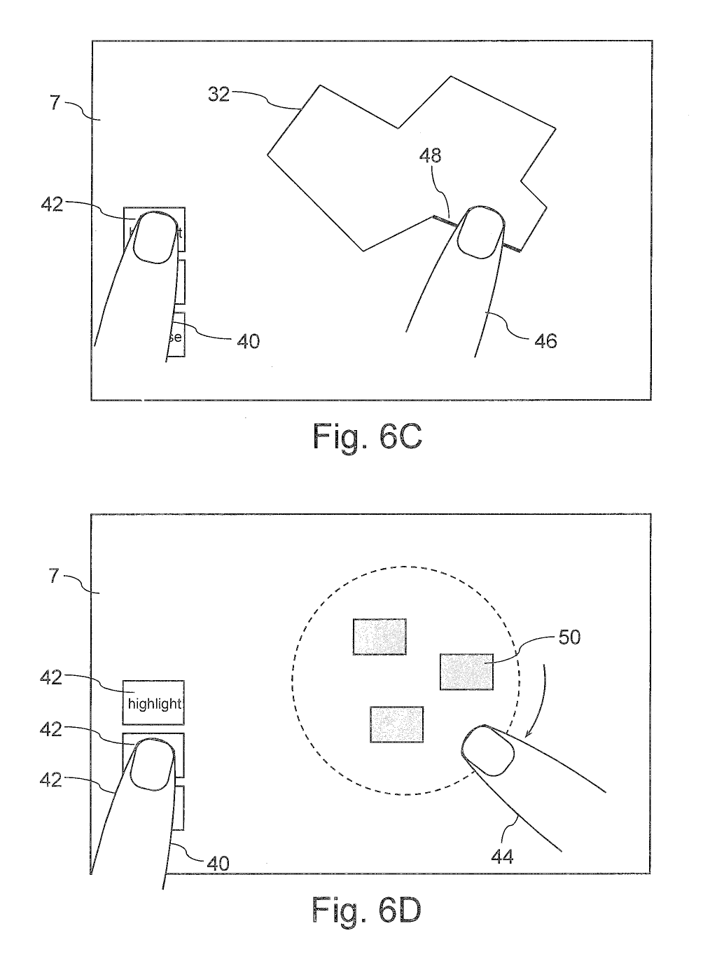

FIGS. 6A to 6D show a third embodiment of the present invention relating to an erase/delete/highlight function. Once again a first set of touches initiates this function via any appropriate mechanism. For instance it may be in the form of a single touch 40 on an appropriate icon 42, as shown in FIG. 6A. Alternatively it may be in the form of a predefined gesture, such as a rapid wiping on the surface 7 for an erase function or a traced exclamation mark for a highlight function. Once the erase/delete/highlight function has been initiated by the first set of touches, it is applied by a second set of touches that defines the area or object to which that function is to be applied. By way of example, for an erase function FIG. 6B shows a second set of touches in the form of a finger 44 erasing those portions of a graphical element 32 over which it passes, while for a highlight function FIG. 6C shows a single touch 46 highlighting a portion 48 of a graphical element, and for a delete function FIG. 6D shows a finger 44 encircling a group of icons 50 to be deleted. Again the first touch need not remain in contact with the surface 7 while the second touch is applied, but for erasing, deleting and highlighting it is advantageous if it does because there is no prospect of the function being disengaged while being applied, unlike the case with conventional single touch or mouse applied functions.

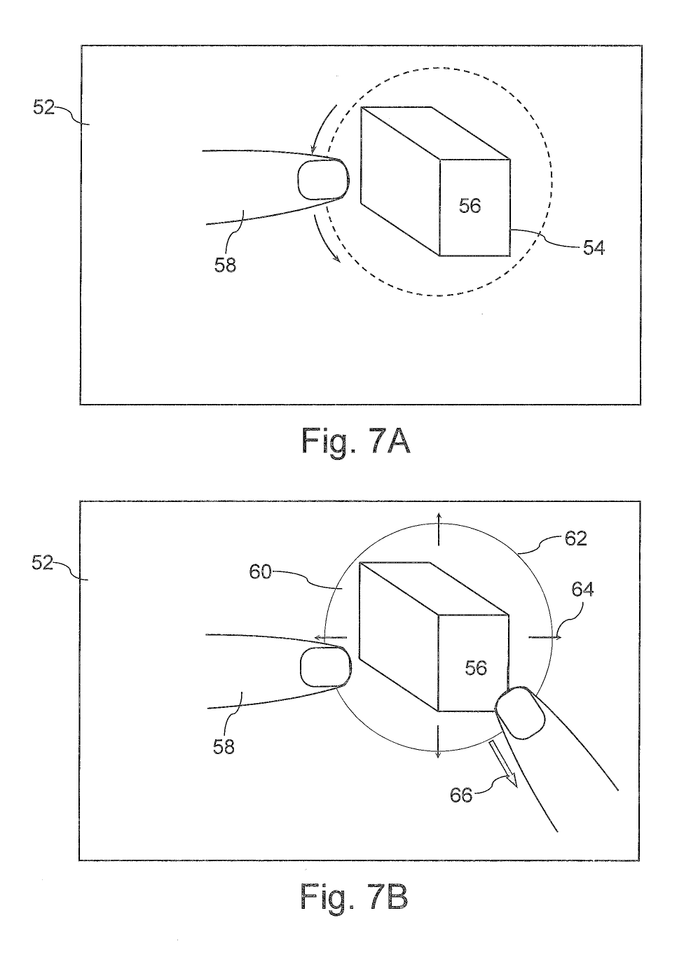

A fourth embodiment according to the present invention is shown in FIGS. 7A and 7B. This embodiment relates to a ‘define plane and rotate’ function. To explain, since a display device 52 is two-dimensional one only sees a two-dimensional view 54 of an otherwise three-dimensional object 56. If it is desired to view alternative elevations or sides of such an object one would proceed as follows. In one embodiment, the ‘define plane and rotate’ function can be initiated by a suitable first set of touches 58 e.g. circling of the object concerned. Once this circling is accomplished the ‘plane’ 60 of the object 56 is defined and the ‘define plane and rotate’ function initiated, as indicated to the user by the display of a circle 62 with arrows 64. The plane 60 of the object is then rotated in any desired direction by application of a second set of touches in the form of a stroke 66 at any point around the aforementioned circle.

If the function remains activated by maintaining the first touch 58, the object can be rotated about a new plane by performing another ‘second touch’ stroke at a different point on the circle 62. Alternatively if the first touch has been removed before commencing the second touch, the ‘define plane and rotate’ function can be recommenced quite simply by performing the encircling touch 58.

Although the invention has been described with reference to specific embodiments, it will be appreciated by those skilled in the art that the invention may be embodied in many other forms.

1. A user interface method for a display device displaying one or more graphical elements, said method comprising the steps of:
initiating a function with a first set of touches on said display device; and
applying said function with a second set of touches.

2. A method according to claim 1, wherein said step of initiating a function comprises selecting or identifying said function.

3. A method according to claim 1, wherein applying said function comprises executing or enabling said function.

4. A method according to claim 1, further comprising the step of, prior to receipt of the first set of touches, defining a location on said display device for said second set of touches to apply said function.

5. A method according to claim 1, wherein one or more touches of said first set of touches define a location on said display device for said second set of touches to apply said function.

6. A method according to claim 1, comprising the step of performing said second set of touches anywhere on a touch-sensitive surface of said display device.

7. A method according to claim 6, wherein said touch-sensitive surface is free from an indication to a user where said second set of touches are to be applied.

8. A user interface method for a display device, said method comprising the steps of:
selecting or identifying a function with a first set of touches on said display device; and
enabling and/or executing said function at a location defined by a second set of touches.

9. A method according to claim 1, wherein said first set of touches initiates a scroll function and said second set of touches is a series of touches or taps, the speed of said touches or taps controlling the speed of said scroll.

10. A method according to claim 1, wherein said first set of touches initiates a rotational function and defines a centre of rotation, and said second set of touches implements rotation around said centre of rotation.

11. A method according to claim 1, wherein said first set of touches initiates an erase, delete or highlight function and said second set of touches implements said erase, delete or highlight function at a location indicated by said second set of touches.

12. A method according to claim 1, wherein said first set of touches initiates a rotation function and defines a plane of view of a graphical element, and the said second set of touches rotates said plane.

13. A method according to claim 1, wherein said first set of touches remains on said display device during application of said function by said second set of touches.
